(19) United States
(12) Patent Application Publication
(10) Pub. No.: US 2025/0276463 A1
(43) Pub. Date: Sep. 4, 2025

(54) CYLINDER KNIFE AND CUTTING DEVICE

(71) Applicant: FUJIAN MEIZHIKOU TECHNOLOGY CO., LTD., FUZHOU (CN)

(72) Inventors: ENHUI ZHANG, FUZHOU (CN); LIUAN ZHANG, FUZHOU (CN)

(21) Appl. No.: 18/979,655

(22) Filed: Dec. 13, 2024

(30) Foreign Application Priority Data
Mar. 4, 2024 (CN) 202420407439.5

(51) Int. Cl. B26D 3/18; B26D 7/06

(52) U.S. Cl. CPC B26D 3/185; B26D 7/0641; B26D 2210/02

(57) ABSTRACT

A cylinder knife and a cutting device includes an annular fixed knife rest and an annular rotary knife rest rotatably sleeved outside the fixed knife rest, which form a cylinder knife structure. Moreover, the fixed knife rest is provided with a first blade component, the rotary knife rest is provided with second blade components disposed at an acute angle with a rotation surface, and an angle opening direction of the acute angle and a rotation direction are the same direction; and when food is sliced after put into the cylinder knife from the upside, large oblique surfaces of the second blade components provide extrusion forces for pressing food into the first blade component while slicing, and finally, the food is cut into specific shapes such as shapes like dices or chips by the first blade component.

### CROSS-REFERENCE TO RELATED APPLICATIONS

This application claims priority to Chinese Patent Application No. 202420407439.5, filed on Mar. 4, 2024, the content of which is incorporated herein by reference in its entirety.

### TECHNICAL FIELD

The present application relates to the technical field of cutting devices, in particular to a cylinder knife and a cutting device.

### BACKGROUND

For food dicing and chipping machines on the current market, one is of a rotating disc type, a feeding hole thereof can only be located in the radius of a circular dish; and the other one is of a reciprocating flat-cutting type, a cutting stroke thereof needs to be three times as large as the size of the feeding hole. For the two working ways, accessories are large in size and cumbersome, great in occupied space and not easy to take, as a result, people's hands are easily cut by knives on the accessories, which seriously affect the user's experience in food processing.

### SUMMARY

The technical problem to be solved in the present application is to provide a cylinder knife and a cutting device, by which sizes of accessories can be reduced, it is not easy to hurt hands, and the user's experience is improved.

In order to solve the above-mentioned technical problem, the present application adopts the technical solutions:

provided is a cylinder knife, including an annular fixed knife rest and an annular rotary knife rest rotatably sleeved outside the fixed knife rest, the rotary knife rest being disposed to be coaxial with the fixed knife rest and taking an axial direction where the rotary knife rest is located as a rotating shaft, the fixed knife rest being provided with a first blade component, the rotary knife rest being provided with second blade components disposed at an acute angle with a rotation surface, and an angle opening direction of the acute angle and a rotation direction being the same direction.

Further, the fixed knife rest is provided with a mounting window, the first blade component is embedded in the mounting window, and an outer surface of the first blade component is flush with an outer surface of the fixed knife rest.

Further, the first blade component consists of a plurality of blades staggered horizontally and vertically, and cutting edges of the blades are all located on one side of the outer surface of the fixed knife rest.

Further, the cutting edges of the blades in the second blade components are located on a side corresponding to a free end of the acute angle.

Further, a plane where the blades in the second blade components are located and the rotation surface are in an externally tangent relationship.

Further, two or more second blade components are provided and are uniformly distributed along the rotation surface of the rotary knife rest.

Provided is a cutting device, including a rack, a feeding rack disposed above the rack, a driving motor disposed on one side of the rack, a discharging rack disposed on the other side of the rack and the cylinder knife; the feeding rack being provided with a feeding hole, and the discharging rack being provided with a discharging hole; and the fixed knife rest being detachably connected to the discharging rack, and an output shaft of the driving motor being fixedly connected to the rotary knife rest.

Further, a cylindrical limiting groove is disposed in a side surface, corresponding to the output shaft of the driving motor and facing to the discharging hole, of the rotary knife rest, and a limiting shaft embedded in the limiting groove and adapted to the limiting groove is disposed on the fixed knife rest corresponding to the limiting groove.

Further, the first blade component is located above the discharging rack and is disposed to correspond to the feeding hole of the feeding rack, and a lower end surface of the discharging rack is obliquely disposed.

The present application has the beneficial effects that:
a cylinder knife provided in the present application includes an annular fixed knife rest and an annular rotary knife rest rotatably sleeved outside the fixed knife rest, which form a cylinder knife structure. Compared with an existing way, the cylinder knife can greatly reduce the spatial waste during the movement of a tool. Moreover, the fixed knife rest is provided with a first blade component, the rotary knife rest is provided with second blade components disposed at an acute angle with a rotation surface, and an angle opening direction of the acute angle and a rotation direction are the same direction; and when food is sliced after put into the cylinder knife from the upside, large oblique surfaces of the second blade components provide extrusion forces for pressing food into the first blade component while slicing, and finally, the food is cut into specific shapes such as shapes like dices or chips by the first blade component. In such a way, sizes of accessories can be reduced, and the accessories are light-weighted and occupy less space; and at the same time, large food can be cut, it is not easy to hurt hands, and the user's experience is improved. The above-mentioned cylinder knife is applied to a cutting device, thereby achieving cut products with small sizes and high safety.

### BRIEF DESCRIPTION OF THE DRAWINGS

FIG. 1 is a schematic structural view of a cutting device in the present application;

FIG. 2 is a side view of a cutting device in the present application;

FIG. 3 is a main view of a cutting device in the present application;

FIG. 4 is a schematic structural view shown when a fixed knife rest of a cutting device is mounted on a discharging rack in the present application;

FIG. 5 is a schematic structural view shown when a fixed knife rest and a rotary knife rest of a cutting device are assembled in the present application;

FIG. 6 is a main view shown without an end cover when a fixed knife rest and a rotary knife rest of a cutting device are assembled in the present application;

FIG. 7 is a schematic structural view of a fixed knife rest of a cutting device in the present application;

FIG. 8 is a schematic structural view of a discharging rack of a cutting device in the present application;

FIG. 9 is a schematic structural view of a discharging rack and a fixed knife rest of a cutting device in the present application; and

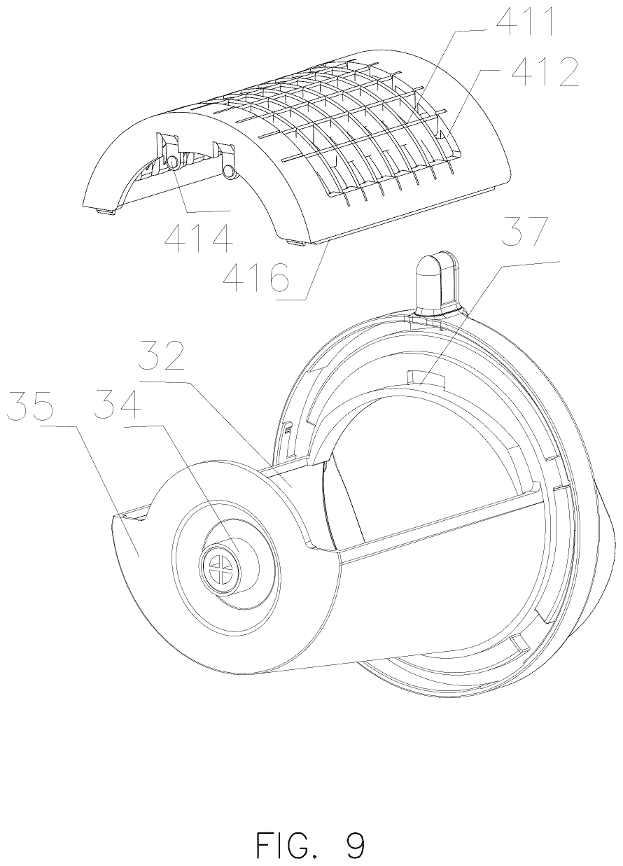

FIG. 10 is a schematic structural view of a rotary knife rest of a cutting device in the present application.

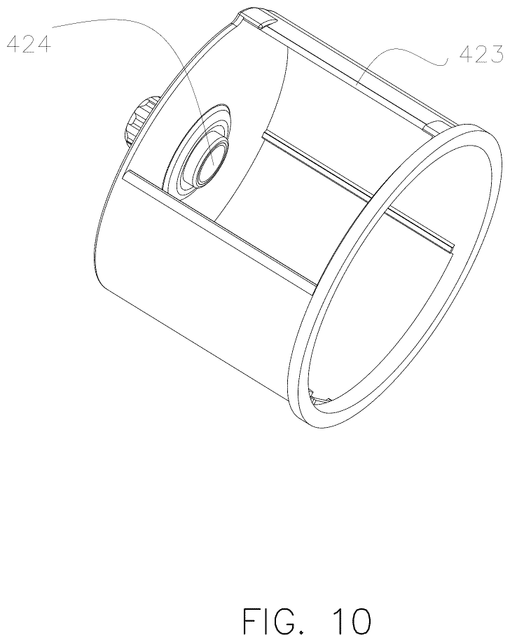

### DETAILED DESCRIPTION OF THE EMBODIMENTS

In order to describe the technical contents and the achieved objects and effects of the present application in detail, the following description is shown in conjunction with implementations and cooperation with the accompanying drawings.

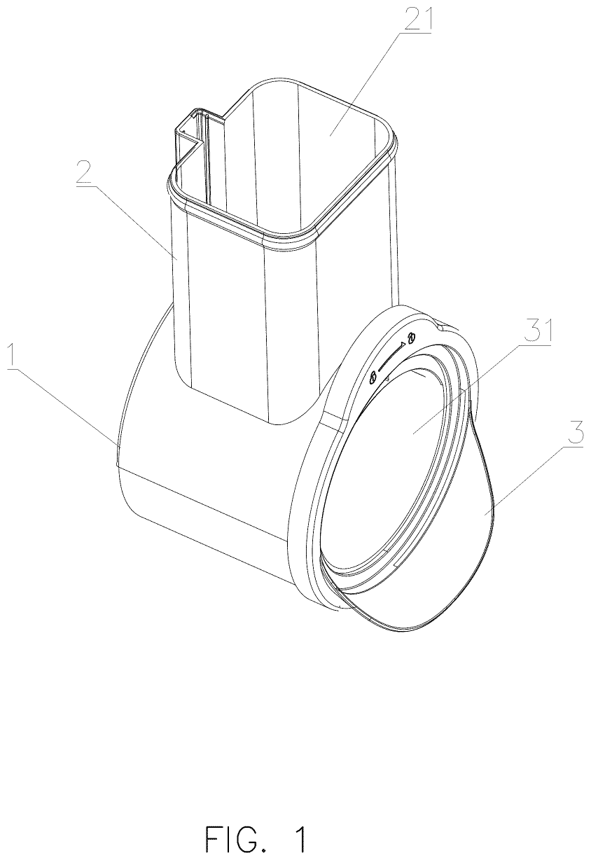

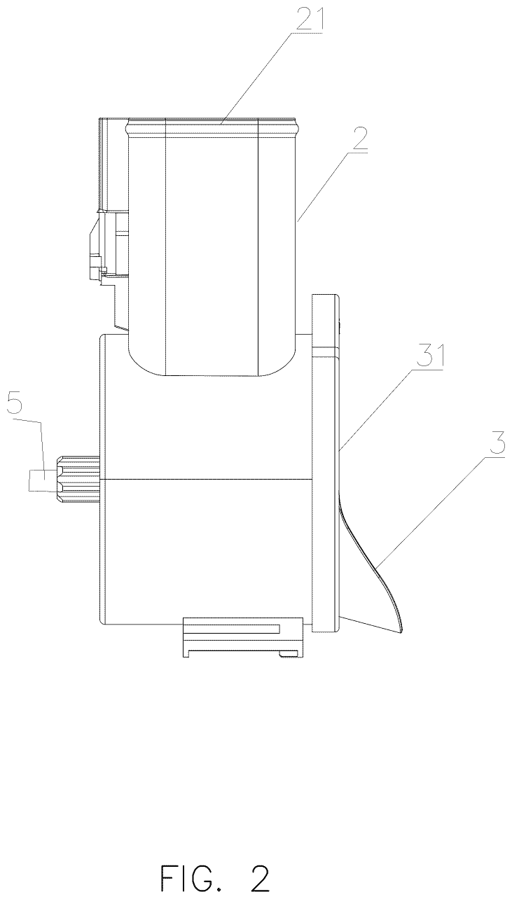

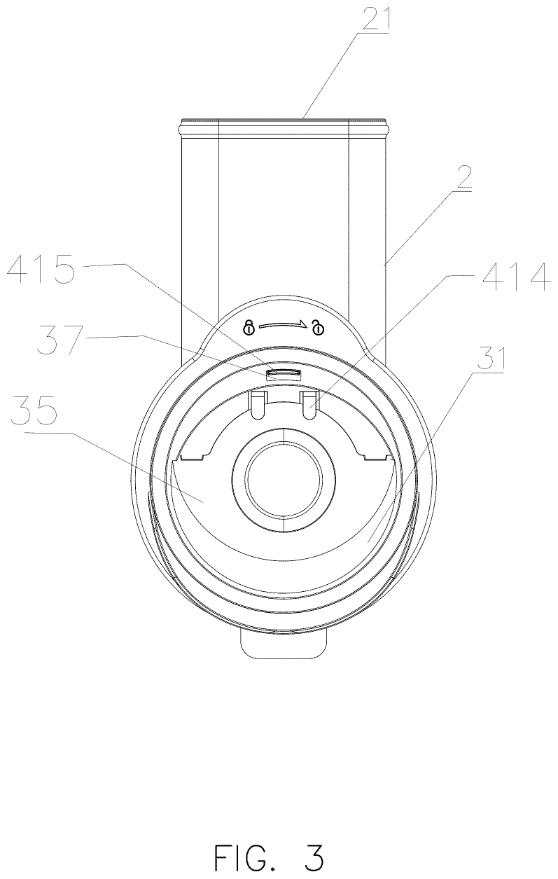

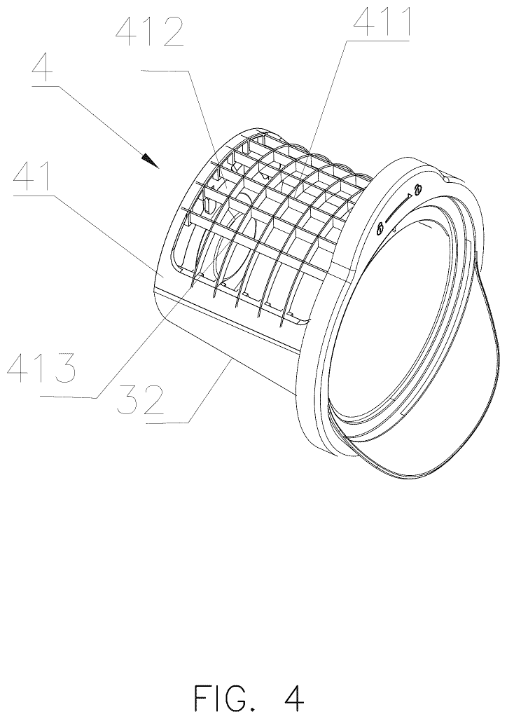

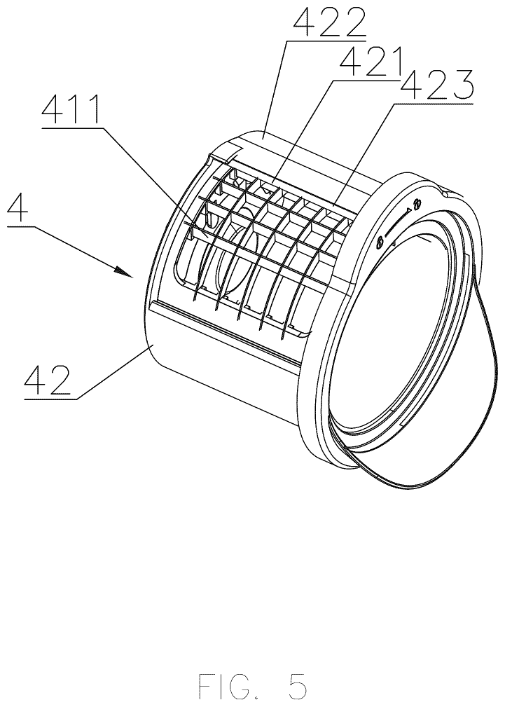

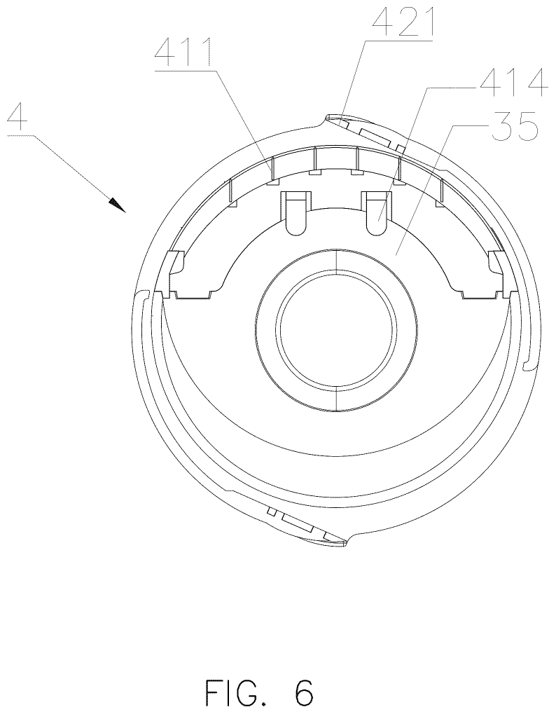

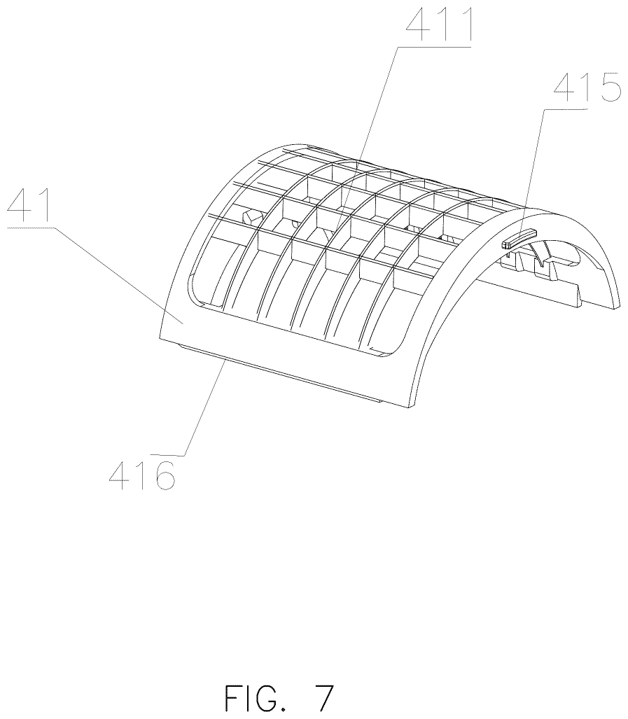

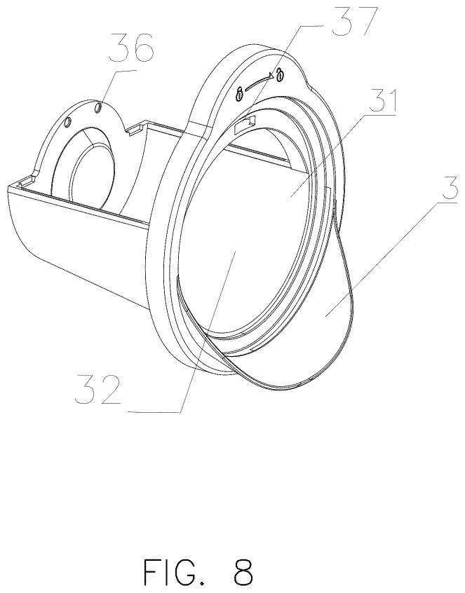

Refer to FIG. 1 to FIG. 8, a cylinder knife provided in the present application includes an annular fixed knife rest and an annular rotary knife rest rotatably sleeved outside the fixed knife rest, the rotary knife rest being disposed to be coaxial with the fixed knife rest and taking an axial direction where the rotary knife rest is located as a rotating shaft, the fixed knife rest being provided with a first blade component, the rotary knife rest being provided with second blade components disposed on a rotation surface 422 of the, rotary knife rest. The second blade components are inclined toward the rotating shaft.

It can be known from the above-mentioned description that the present application has the beneficial effects that a cylinder knife provided by the present application includes an annular fixed knife rest and an annular rotary knife rest rotatably sleeved outside the fixed knife rest, which form a cylinder knife structure. Compared with an existing way, the cylinder knife can greatly reduce the spatial waste during the movement of a tool. Moreover, the fixed knife rest is provided with a first blade component, the rotary knife rest is provided with second blade components disposed at an acute angle with a rotation surface, and an angle opening direction of the acute angle and a rotation direction are the same direction; and when food is sliced after put into the cylinder knife from the upside, large oblique surfaces of the second blade components provide extrusion forces for pressing food into the first blade component while slicing, and finally, the food is cut into specific shapes such as shapes like dices or chips by the first blade component. In such a way, sizes of accessories can be reduced, and the accessories are light-weighted and occupy less space; and at the same time, large food can be cut, it is not easy to hurt hands, and the user's experience is improved.

Further, the fixed knife rest is provided with a mounting window 412, the first blade component is embedded in the mounting window 412, and an outer surface of the first blade component is flush with an outer surface of the fixed knife rest.

It can be known from the above-mentioned description that the outer surface of the first blade component is flush with the outer surface of the fixed knife rest, which makes food rapidly contact with the first blade component, so that the cutting efficiency can be increased.

Further, the first blade component consists of a plurality of blades staggered horizontally and vertically, and cutting edges 413 of the blades are all located on the outer surface of the fixed knife rest.

It can be known from the above-mentioned description that various shapes such as dices or chips can be achieved by adopting the formation of the blades staggered horizontally and vertically.

Further, the cutting edges of the blades in the second blade components are located on a side corresponding to a free end of the acute angle.

Further, a plane where the blades in the second blade components are located and the rotation surface are in an externally tangent relationship.

Further, two or more second blade components are provided and are uniformly distributed along the rotation surface of the rotary knife rest.

It can be known from the above-mentioned description that by means of the above-mentioned design, the cutting efficiency can be increased.

Refer to FIG. 1 to FIG. 8, the present application further provides a cutting device, including a rack 1, a feeding rack 2 disposed above the rack, a driving motor disposed on one side of the rack 1, a discharging rack 3 disposed on the other side of the rack and the cylinder knife 4; the feeding rack 2 being provided with a feeding hole 21, and the discharging rack 3 being provided with a discharging hole 31; and the fixed knife rest 41 being detachably connected to the discharging rack 3, and an output shaft 5 of the driving motor being fixedly connected to the rotary knife rest 42.

It can be known from the above-mentioned description that the present application has the beneficial effects that the above-mentioned cylinder knife is applied to a cutting device, thereby achieving cut products with small sizes and high safety.

Further, a cylindrical limiting groove 424 is disposed in a side surface, corresponding to the output shaft 5 of the driving motor and facing to the discharging hole 31, of the rotary knife rest 42, and a limiting shaft 34 embedded in the limiting groove 424 and adapted to the limiting groove 424 is disposed on the discharging rack 3 corresponding to the limiting groove.

It can be known from the above-mentioned description that by means of the above-mentioned design, the cooperation between the limiting groove and the limiting shaft avoids the problems of deviation and shedding, thereby ensuring the stability of structural assembly.

Further, the first blade component 411 is located above the discharging rack 3 and is disposed to correspond to the feeding hole of the feeding rack, and a lower end surface of the discharging rack is obliquely disposed.

It can be known from the above-mentioned description that by means of the above-mentioned design, the food cut by the first blade component falls into the discharging rack and is convenient to slide out under the action of the oblique surface on the lower end.

Refer to FIG. 1 to FIG. 8, embodiment 1 of the present application is that:

a cutting device provided in the present application includes a rack 1, a feeding rack 2 disposed above the rack, a driving motor disposed on one side of the rack, a discharging rack 3 disposed on the other side of the rack and the cylinder knife 4; and the feeding rack 2 being provided with a feeding hole 21, and the discharging rack 3 being provided with a discharging hole 31. The feeding rack is a cylindrical shell disposed vertically. The driving motor can adopt an existing product and is recumbently placed when being disposed so that the output shaft thereof is in a horizontal state.

A cylindrical limiting groove is disposed in a side surface, corresponding to the output shaft of the driving motor and facing to the discharging hole 31, of the rotary knife rest, and a limiting shaft embedded in the limiting groove and adapted to the limiting groove is disposed on the fixed knife rest corresponding to the limiting groove. There is a gap between the limiting groove and the limiting shaft, which is used for not only meeting a demand on assembly, but also meeting a demand on an activity space required by relative movement of the limiting groove and the limiting shaft. During assembly, the limiting shaft is inserted into the limiting groove to achieve cooperation, at the same time, an axial outlet end of the fixed knife rest is fixed to an end surface of the discharging hole 31 by means of rotatable and detachable connection to form two end fixation, which ensures the stability in the axial and circumferential directions of the fixed knife rest and avoids the problems of deviation and shedding, thereby ensuring the stability of structural assembly.

The above-mentioned cylinder knife 4 includes an annular fixed knife rest 41 and an annular rotary knife rest 42 rotatably sleeved outside the fixed knife rest, and the fixed knife rest is detachably connected to the discharging rack. Specifically, a notch is disposed in an upper part of the discharging rack, the fixed knife rest is disposed in the notch and is detachably connected to an edge where the notch is located, and the output shaft of the driving motor is fixedly connected to the rotary knife rest.

The rotary knife rest is disposed to be coaxial with the fixed knife rest and takes an axial direction where the rotary knife rest is located as a rotating shaft, there is a gap between the fixed knife rest and the rotary knife rest, and the fixed knife rest 41 is provided with a first blade component 411. Specifically, the fixed knife rest 41 is provided with a mounting window 412, the first blade component 411 is embedded in the mounting window 412, and an outer surface of the first blade component 411 is flush with an outer surface of the fixed knife rest 41, which makes food rapidly contact with the first blade component, so that the cutting efficiency can be increased. At the same time, interference between the second blade component and the first blade component during the rotation of the rotary knife rest can be avoided. The first blade component is located above the discharging rack and is disposed to correspond to the feeding hole of the feeding rack, and a lower end surface 311 of the discharging rack is obliquely disposed. The food cut by the first blade component falls into the discharging rack and is convenient to slide out under the action of the oblique surface on the lower end.

In the present embodiment, the first blade component 411 consists of a plurality of blades staggered horizontally and vertically, and cutting edges 423 of the blades are all located on one side of the outer surface of the fixed knife rest, so that various shapes such as dices and chips can be achieved. Specifically, the first blade component includes metal blades and a support for fixing the metal blades, and the metal blades, staggered horizontally and vertically, of the first blade component are non-detachably connected.

The above-mentioned first blade component is divided into the following three types:
first: a blade component disposed horizontally and vertically is used for dicing. During mounting, horizontally and vertically staggered blades are fixedly connected to a plastic support;
second: a blade component disposed horizontally is used for chipping. During mounting, horizontal blades are fixedly connected to a plastic support; and
third: a blade component disposed vertically is used for chipping. During mounting, vertical blades are fixedly connected to a plastic support.

The blade components in the above-mentioned three forms are detachably connected to the fixed knife rest. Of course, a way of fixation by means of non-detachable connection can also be adopted, and thus, an overall component is formed.

The rotary knife rest 42 is provided with second blade components 421 disposed at an acute angle with a rotation surface, and an angle opening direction of the acute angle and a rotation direction being the same direction. The cutting edges 423 of the blades in the second blade components are located on a side corresponding to a free end of the acute angle. A plane where the blades in the second blade components are located and the rotation surface are in an externally tangent relationship.

Two or more second blade components 421 are provided and are uniformly distributed along the rotation surface of the rotary knife rest. By means of the above-mentioned design, the cutting efficiency can be increased. Specifically, the two second blade components are symmetrically distributed on the rotary knife rest with the rotating shaft as a symmetry axis.

The fixed knife rest 41 comprises support pieces 414 extending from a side wall of the fixed knife rest 41. The discharging rack 3 comprises a side board 35 and a rack body 32 connected to the side board 35. The side board 35 defines positioning recesses 36. When the fixed knife rest 41 is mounted on the discharging rack 3, the support pieces 414 are respectively snapped in the positioning recesses 36.

The fixed knife rest 41 comprises positioning strips 416 disposed on bottom surfaces of the fixed knife rest 41, and when the fixed knife rest 41 is mounted on the discharging rack 3, the positioning strips 416 abut against an inner wall of the rack body 32 of the discharging rack 3.

The fixed knife rest 41 comprises a positioning block 415, the discharging rack 3 defines a positioning hole 37, and when the fixed knife rest 41 is mounted on the discharging rack 3, the positioning block 415 is positioned in the positioning hole 37.

In conclusion, a cylinder knife provided in the present application includes an annular fixed knife rest and an annular rotary knife rest rotatably sleeved outside the fixed knife rest, which form a cylinder knife structure. Compared with an existing way, the cylinder knife can greatly reduce the spatial waste during the movement of a tool. Moreover, the fixed knife rest is provided with a first blade component, the rotary knife rest is provided with second blade components disposed at an acute angle with a rotation surface, and an angle opening direction of the acute angle and a rotation direction are the same direction; and when food is sliced after put into the cylinder knife from the upside, large oblique surfaces of the second blade components provide extrusion forces for pressing food into the first blade component while slicing, and finally, the food is cut into specific shapes such as shapes like dices or chips by the first blade component. In such a way, sizes of accessories can be reduced, and the accessories are light-weighted and occupy less space; and at the same time, large food can be cut, it is not easy to hurt hands, and the user's experience is improved. The above-mentioned cylinder knife is applied to a cutting device, thereby achieving cut products with small sizes and high safety.

Above descriptions are only embodiments of the present application, and are not intended to hence limit the patent scope of the present application. Any equivalent transformations made according to the contents of the description and the accompanying drawings of the present application are directly or indirectly applied to the related art and also fall within the patent protection scope of the present application in a similar way.

What is claimed is:

1. A cylinder knife, comprising an semi-annular fixed knife rest and an annular rotary knife rest rotatably sleeved outside the fixed knife rest, the rotary knife rest being disposed to be coaxial with the fixed knife rest and taking an axial direction where the rotary knife rest is located as a rotating shaft, the fixed knife rest being provided with a first blade component, the rotary knife rest being provided with second blade components disposed inclined upward, the rotary knife rest rotates along an extension direction of the second blade components, the fixed knife rest is provided with a mounting window, the first blade component is embedded in the mounting window, and an outer surface of the first blade component is flush with an outer surface of the fixed knife rest.

2. (canceled)

3. The cylinder knife according to claim 1, wherein the first blade component consists of a plurality of blades staggered horizontally and vertically, and cutting edges of the blades of he first blade component are all located on the outer surface of the fixed knife rest.

4. The cylinder knife according to claim 1, wherein cutting edges of blades in the second blade components are inclined toward the rotating shaft.

5. (canceled)

6. The cylinder knife according to claim 1, wherein two or more second blade components are provided and are uniformly distributed on the rotary knife rest.

7. A cutting device, comprising a rack, a feeding rack disposed above the rack, a discharging rack disposed on the other side of the rack and an cylinder knife;
wherein the cylinder knife comprises an semi-annular fixed knife rest and an annular rotary knife rest, the fixed knife rest being detachably connected to the discharging rack, the fixed knife rest is only allowed to be mounted in the cutting device by connecting to the discharging rack, the rotary knife rest is rotatably sleeved outside the fixed knife rest and the discharging rack, the rotary knife rest being disposed to be coaxial with the fixed knife rest and taking an axial direction where the rotary knife rest is located as a rotating shaft,
the fixed knife rest being provided with a first blade component, the rotary knife rest being provided with second blade components disposed inclined upward, the rotary knife rest rotates along an extension direction of the second blade components, the fixed knife rest is provided with a mounting window, the first blade component is embedded in the mounting window, and an outer surface of the first blade component is flush with an outer surface of the fixed knife rest;
the feeding rack being provided with a feeding hole, and the discharging rack being provided with a discharging hole.

8. The cutting device according to claim 7, wherein a cylindrical limiting groove is disposed in a side surface, facing to the discharging hole, of the rotary knife rest, and a limiting shaft embedded in the limiting groove and adapted to the limiting groove is disposed on the discharging rack corresponding to the limiting groove.

9. The cutting device according to claim 7, wherein the first blade component is located above the discharging rack and is disposed to correspond to the feeding hole of the feeding rack, a rack body of the discharging rack is obliquely disposed, the feeding hole is perpendicular to the discharging hole, and when the rotary knife rest rotates, food cut by the first blade component and the second blade components are discharged from the discharging hole under a centrifugal force.

10. The cutting device according to claim 7, wherein the fixed knife rest comprises support pieces extending from a side wall of the fixed knife rest, the discharging rack comprises a side board and a rack body connected to the side board, the side board defines positioning recesses, and when the fixed knife rest is mounted on the discharging rack, the support pieces are respectively snapped in the positioning recesses.

11. The cutting device according to claim 7, wherein the fixed knife rest comprises positioning strips disposed on bottom surfaces of the fixed knife rest, and when the fixed knife rest is mounted on the discharging rack, the positioning strips abut against an inner wall of a rack body of the discharging rack.

12. The cutting device according to claim 7, wherein the fixed knife rest comprises a positioning block, the discharging rack defines a positioning hole, and when the fixed knife rest is mounted on the discharging rack, the positioning block is positioned in the positioning hole.

13. The cutting device according to claim 7, wherein a size of the mounting window is greater than a size of the feeding hole.
